(19) United States
(12) Patent Application Publication
(10) Pub. No.: US 2024/0193736 A1
(43) Pub. Date: Jun. 13, 2024

(54) HIGH DYNAMIC RANGE (HDR) FUSION MECHANISM OF MULTI-EXPOSURE IMAGES

(71) Applicant: CISTA SYSTEM CORP., Grand Cayman (KY)

(72) Inventors: Yang-Ting CHOU, ZHUBEI CITY (TW); Zhaojian LI, FREMONT, CA (US)

(21) Appl. No.: 18/077,166

(22) Filed: Dec. 7, 2022

(51) Int. Cl. G06T 5/50; G06T 5/00; G06T 7/20

(52) U.S. Cl. CPC G06T 5/50; G06T 5/002; G06T 5/009; G06T 7/20; G06T 2207/10024; G06T 2207/20021; G06T 2207/20076; G06T 2207/20208; G06T 2207/20221

(57) ABSTRACT

This application describes methods and systems for High Dynamic Range (HDR) image fusion on Low Dynamic Range (LDR) images that avoid ghosting effect. An example method may start with detecting a plurality of motion pixels on the plurality of LDR images. For each of the motion pixels, a plurality of pixel values may be obtained. Each pixel value represents a brightness of the pixel in the corresponding LDR image. The method may then construct a fusion tensor comprising a plurality of dimensions respectively corresponding to the plurality of exposure settings. Each motion pixel may be mapped to the fusion tensor based on the plurality of the pixel values of the motion pixel to obtain a fusion weight. The fusion weights of the motion pixels may provide guidance to the HDR fusion on the LDR images.

### TECHNICAL FIELD

The disclosure relates generally to an apparatus and device for fusing multiple exposure images in motion areas.

### BACKGROUND

High Dynamic Range (HDR) imaging is widely used in consumer photography, autonomous driving, and surveillance systems. An HDR image is usually reconstructed using multi-exposure fusion schemes, in which a sequence of low dynamic range (LDR) images captured at different exposures are fused into the HDR image. Reconstructing ghosting-free HDR images of dynamic scenes from a set of LDR images is a challenging task. The current popular HDR sensors are frame-based HDR involving digital overlap (stagger). Each exposure of these HDR sensors has to wait for the end of another exposure time, which may produce a poor fusion effect on moving objects and result in a ghosting effect. This disclosure describes an HDR fusion method and system that adopt a multi-region fusion tensor for avoiding the ghosting effect.

### SUMMARY

Various embodiments of this specification may include hardware circuits, systems, and methods related to HDR imaging that use a multi-region fusion tensor.

In some aspects, the techniques described herein relate to a method for generating images, including: obtaining a plurality of images of a scene using a plurality of exposure settings; detecting a plurality of motion pixels on the plurality of images; for each of the motion pixels, obtaining a plurality of pixel values of the motion pixel respectively in the plurality of images; constructing a fusion tensor including a plurality of dimensions respectively corresponding to the plurality of exposure settings, wherein: each dimension of the fusion tensor includes a pixel value range, and the fusion tensor includes a plurality of weights, each weight being indexed by a combination of pixel values from the plurality of dimensions of the fusion tensor; for each of the motion pixels, mapping the motion pixel to the fusion tensor based on the plurality of the pixel values of the motion pixel to obtain a fusion weight corresponding to the motion pixel; and performing image fusion on the plurality of images based on the plurality of fusion weights corresponding to the plurality of motion pixels.

In some aspects, the plurality of images include a plurality of low dynamic range (LDR) images, and the plurality of exposure settings include at least a short-exposure and a long-exposure.

In some aspects, the detecting the plurality of motion pixels includes: performing pixel value normalization on the plurality of images based on the plurality of exposure settings to obtain a plurality of normalized images; constructing a motion probability map based on differences among the plurality of normalized images; and performing dilation process on the motion probability map to optimize continuity of motion.

In some aspects, the constructing the motion probability map includes: selecting one of the plurality of images as a base frame; for each of the plurality of images other than the base frame, obtaining a pixel-wise optical flow map by inputting the image and the base frame into a trained motion estimation machine learning model; and constructing the motion probability map based on the pixel-wise optical flow map for each of the plurality of images other than the base frame.

In some aspects, the detecting the plurality of motion pixels further includes: performing noise level normalization on the plurality of images.

In some aspects, the constructing the fusion tensor includes: determining a number of bits representing each pixel in the plurality of images; constructing each dimension of the fusion tensor covering a range of value based on the number of bits; dividing the fusion tensor into a plurality of regions, each region corresponding to one of the plurality of exposure settings; and generating the plurality of weights of the fusion tensor, wherein weights in a same region are same.

In some aspects, the plurality of exposure settings include a long-exposure setting and a short-exposure setting, and the fusion tensor is a 2-dimensional matrix including a long-exposure dimension and a short-exposure dimension, and the dividing the fusion tensor into the plurality of regions includes: dividing the 2-dimensional matrix into: a first region and a second region both corresponding to the long-exposure setting, wherein the first region and the second region are connected; and a third region and a fourth region both corresponding to the short-exposure setting, wherein the third region and the fourth region are disconnected.

In some aspects, the dividing the 2-dimensional matrix includes dividing the 2-dimensional matrix using a hyperbola curve and a pair of linear lines.

In some aspects, the determining the plurality of pixel values for each motion pixel respectively in the plurality of images includes: determining a brightness value of the motion pixel in each of the plurality of images.

In some aspects, the determining the plurality of pixel values for each motion pixel respectively in the plurality of images includes: in response to the motion pixel including a plurality of color channels, determining a brightness value of the motion pixel in each of the plurality of color channels in each of the plurality of images.

In some aspects, the fusion weight corresponding to the motion pixel identifies one of the plurality of images.

In some aspects, the performing image fusion on the plurality of images based on the plurality of fusion weights corresponding to the plurality of motion pixels includes: for each of the plurality of motion pixels, adopting the motion pixel from the one image identified by the fusion weight corresponding to the motion pixel.

In some aspects, the method may further include: for pixels other than the plurality of motion pixels, performing the image fusion on the plurality of images based on fusion weights computed using linear or non-linear curves.

In some aspects, the techniques described herein relate to a system, including one or more processors and one or more non-transitory computer-readable memories coupled to the one or more processors and configured with instructions executable by the one or more processors to cause the system to perform operations including: obtaining a plurality of images of a scene using a plurality of exposure settings; detecting a plurality of motion pixels on the plurality of images; for each of the motion pixels, obtaining a plurality of pixel values of the motion pixel respectively in the plurality of images; constructing a fusion tensor including a plurality of dimensions respectively corresponding to the plurality of exposure settings, wherein: each dimension of the fusion tensor includes a pixel value range, and the fusion tensor includes a plurality of weights, each weight being indexed by a combination of pixel values from the plurality of dimensions of the fusion tensor; for each of the motion pixels, mapping the motion pixel to the fusion tensor based on the plurality of the pixel values of the motion pixel to obtain a fusion weight corresponding to the motion pixel; and performing image fusion on the plurality of images based on the plurality of fusion weights corresponding to the plurality of motion pixels.

In some aspects, the techniques described herein relate to a non-transitory computer-readable storage medium configured with instructions executable by one or more processors to cause the one or more processors to perform operations including: obtaining a plurality of images of a scene using a plurality of exposure settings; detecting a plurality of motion pixels on the plurality of images; for each of the motion pixels, obtaining a plurality of pixel values of the motion pixel respectively in the plurality of images; constructing a fusion tensor including a plurality of dimensions respectively corresponding to the plurality of exposure settings, wherein: each dimension of the fusion tensor includes a pixel value range, and the fusion tensor includes a plurality of weights, each weight being indexed by a combination of pixel values from the plurality of dimensions of the fusion tensor; for each of the motion pixels, mapping the motion pixel to the fusion tensor based on the plurality of the pixel values of the motion pixel to obtain a fusion weight corresponding to the motion pixel; and performing image fusion on the plurality of images based on the plurality of fusion weights corresponding to the plurality of motion pixels.

These and other features of the systems, methods, and hardware devices disclosed, and the methods of operation and functions of the related elements of structure and the combination of parts and economics of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates an HDR image with ghosting effect and an HDR image without ghosting effect, according to some embodiments of this specification.

FIG. 2 illustrates an exemplary block diagram for HDR fusion using a multi-region fusion tensor, according to some embodiments of this specification.

FIG. 3 illustrates an exemplary pipeline for computing motion weights for pixels, according to some embodiments of this specification.

FIG. 4A illustrates an exemplary 2-dimensional fusion tensor for HDR fusion, according to some embodiments of this specification.

FIG. 4B illustrates another exemplary 2-dimensional fusion tensor for HDR fusion, according to some embodiments of this specification.

FIG. 4C illustrates an exemplary 3-dimensional fusion tensor for HDR fusion, according to some embodiments of this specification.

FIG. 5 illustrates an exemplary method for HDR fusion using a fusion tensor, according to some embodiments of this specification.

FIG. 6 is a schematic diagram of an example computing system for HDR fusion using a fusion tensor, according to some embodiments of this specification.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown, but is to be accorded the widest scope consistent with the principles and features disclosed herein.

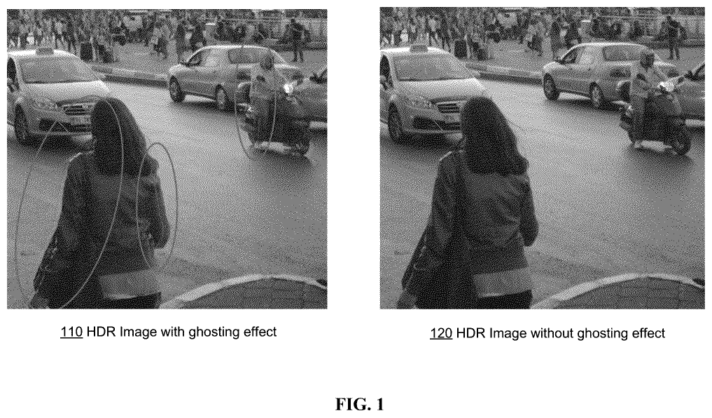

As described in the background section, the multi-exposure HDR fusion schemes involve capturing a sequence of LDR images at different exposures and applying a variety of computational methods to construct the HDR image based on the LDR images. The images with different exposures may be captured using a single sensor by adjusting its exposure over time. When one or more objects in the scene move while the images are being captured, the final fusion result may suffer ghosting effect, as shown in picture 110 of FIG. 1. The rest of this disclosure describes a method and a computing device to perform the HDR fusion with a fusion tensor. The fusion tensor is used as guidance on how the motion pixels in the LDR images should be fused to generate the HDR image with minimal or no ghosting effect, as shown in picture 120 of FIG. 1.

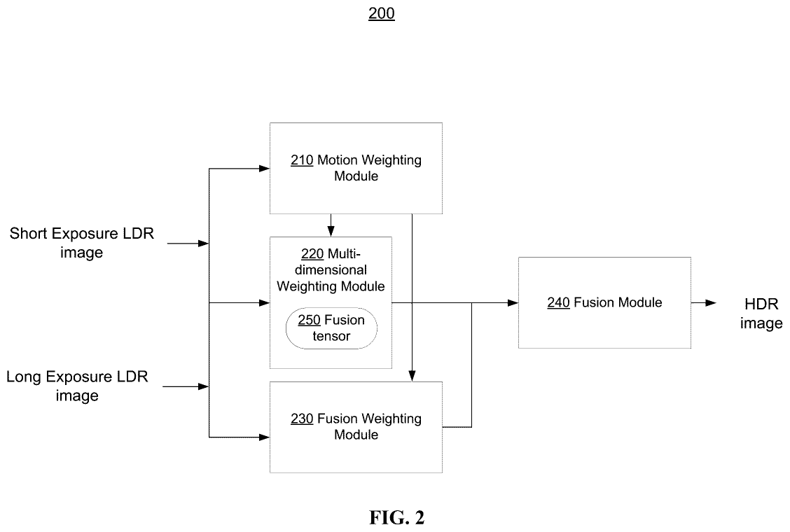

FIG. 2 illustrates an exemplary block diagram 200 for HDR fusion using a multi-region fusion tensor, according to some embodiments of this specification. Block diagram 200 uses a two-exposure fusion scheme as an example. The pipeline may be easily expanded to other multi-exposure fusion schemes (e.g., involving three or more LDR images).

As shown, the input of block diagram 200 includes a short-exposure LDR image and a long-exposure LDR image. These two LDR images may be captured using the same sensor by adjusting its exposure settings over time.

In some embodiments, the HDR fusion process in block diagram 200 includes four modules: a motion weighting module 210, a multi-dimensional weighting module 220, a fusion weighting module 230, and a fusion module 240. The modulization is based on the different functional phases of the HDR fusion process. Depending on the implementation, the process may include fewer, more, or alternative modules. The modules may be implemented as software, Application Specific Integrated Circuit (ASIC), or Field Programmable Gate Array (FPGA).

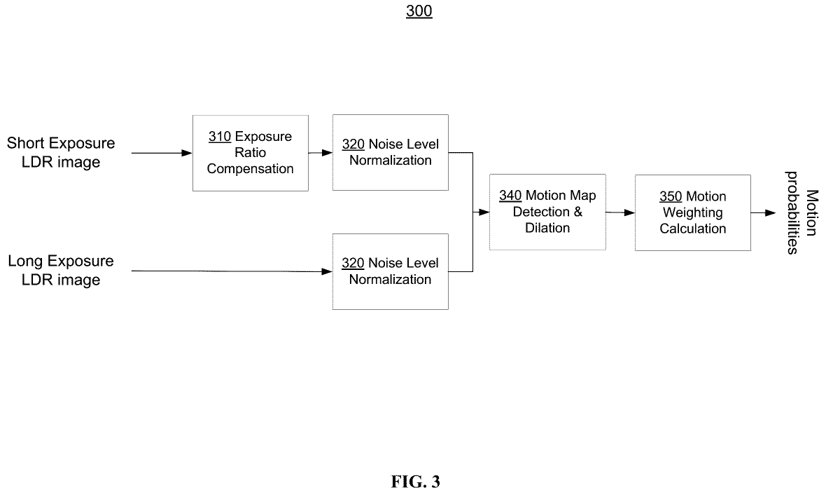

In some embodiments, the motion weighting module 210 may be configured to estimate the motion probabilities (may also be referred to as motion weights) of pixels in the input LDR images and thereby to identify the motion pixels in the LDR images. The motion probability of a pixel indicates how likely the pixel is part of a moving object in the scene captured by the LDR images. For the convenience of description, the motion pixels at the same location in each of the input LDR images are collectively referred to as the same motion pixel. Exemplary details of the motion probability estimation are illustrated in FIG. 3.

In some embodiments, the multi-dimensional weighting module 220 may be configured to determine fusion weights for the identified motion pixels based on (1) pixel values of the motion pixels and (2) a fusion tensor 250. Each motion pixel exists in all of the input LDR images and has a pixel value representing the pixel's brightness (may also be called intensity) in each of the input LDR images. Thus, if the number of input LDR images is an integer K (K is greater than 2), each motion pixel has K pixel values.

For example, in a grey-scale image, the pixel value of a pixel in each LDR image may include a scalar value representing the brightness (intensity) of the pixel in the corresponding LDR image. As another example, in a color image with a plurality of color channels (e.g., RGB pixel has three color channels), the pixel value of a pixel may include a multi-dimensional vector, each dimension corresponding to one color channel. That is, the values in the vector represent the pixel's brightness or intensity in the corresponding color channels.

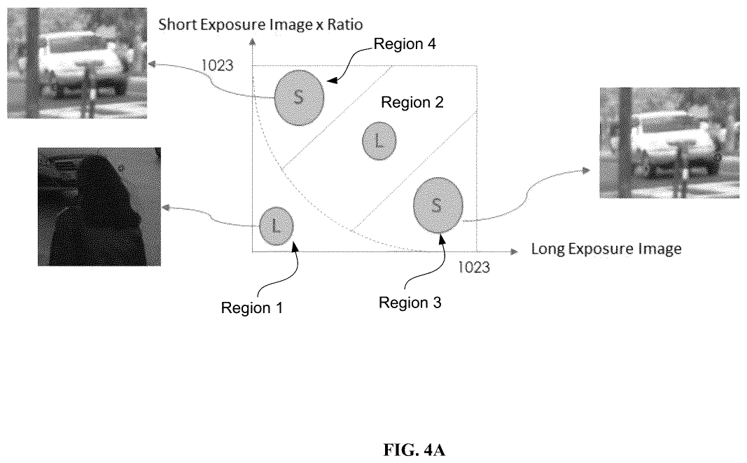

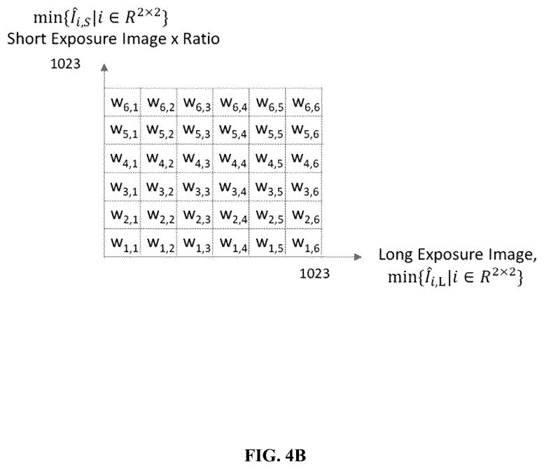

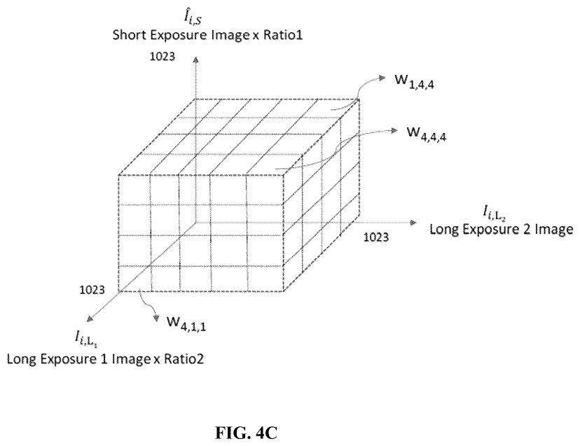

For each motion pixel, its pixel values may be mapped to a region or a weight in the fusion tensor 250. The mapped region or weight may be used to determine the fusion weight for the motion pixel. In some embodiments, the fusion tensor 250 may be pre-calculated and pre-stored by the multi-dimensional weighting module 220 based on the exposure settings. The fusion tensor 250 serves as a fusion policy that assigns a fusion weight to a given pixel. Depending on the number of exposure settings, the fusion tensor 250 may have a same number of dimensions. For instance, the HDR fusion process 200 involves two exposure settings, the corresponding fusion tensor 250 may be a 2-dimensional (2D) matrix (more detailed descriptions in FIGS. 4A and 4B). Each dimension of the fusion tensor 250 may cover a pixel value range in the corresponding exposure setting. In some embodiments, the pixel value ranges for different exposure settings may be normalized so that the dimensions of the fusion tensor 250 cover the same pixel value range. For example, if the ratio of long-exposure time to short-exposure time is 32 times, then all pixel values of pixels in the short-exposure LDR image are multiplied by 32.

While the multi-dimensional weighting module 220 determines fusion weights for motion pixels, the fusion weighting module 230 may be configured to determine fusion weights for other non-motion pixels in the LDR images. Since these non-motion pixels would not result in ghosting effect, their weights may be determined using a linear curve, Debevec & Malik weighting function, a non-linear curve, etc. In some embodiments, the fusion weight of a pixel is computed based on the brightness values of the pixel across all the LDR images.

After obtaining the fusion weights for motion pixels from the multi-dimensional weighting module 220 and the fusion weights for non-motion pixels from the fusion weighting module 230, the fusion module 240 may perform image fusion on the LDR images at the pixel level using the fusion weights of the pixels. The output of the fusion module 240 includes the HDR image constructed based on the LDR images.

FIG. 3 illustrates an exemplary pipeline 300 for computing motion weights/probabilities for pixels, according to some embodiments of this specification. The pipeline 300 still uses two exposure settings as an example, and may be expanded to three or more exposure settings by a person skilled in the art.

In some embodiments, the pipeline 300 may include four operations: exposure ratio compensation 310, noise level normalization 320, motion map detection and dilation 340, and motion weighting calculation 350. Depending on the implementation, some specific steps may be omitted from or added to the pipeline 300.

As explained in FIG. 2, the exposure ratio of all pixels from different exposure settings may be normalized before performing motion weighting or multi-dimensional weighting calculations. The purposes of normalization include scaling the pixel values (e.g., pixel brightness or intensity) from different exposures into a same pixel value scale. For instance, all brightness needs to be normalized to be consistent, based on the proportional relationship between exposures. If the ratio of long-exposure time to short-exposure time is 32 times, then all pixel values of short-exposure LDR image are multiplied by 32. In some embodiments, the longest exposure setting is used as the target scale, and all other shorter exposure settings are scaled up toward the target scale. After scaling, the pixels have a uniform light intensity distribution. As shown, with two exposure LDR images, the exposure ratio compensation 310 only applies to the short-exposure LDR image.

After performing exposure ratio compensation 310 on the short-exposure LDR image, both the short and long-exposure LDR images may go through a noise level normalization 320 process. This step is needed because the noise performance of the same sensor may be inconsistent at different exposure settings. For example, the input LDR images from the same sensor may follow a Poisson noise distribution in relation to the exposure time.

Once the input LDR images are normalized, a motion probability map may be computed based on the difference between the normalized pixels in the LDR images. For instance, the LDR images may first be sorted by exposure time. One of the LDR images may be selected as a base frame. For each of the LDR images other than the base frame, a pixel-wise optical flow map may be computed by inputting the LDR image and the base frame into a trained motion estimation machine learning model. The machine learning model may be a convolutional neural network with at least three layers. The neural network may be trained using historical LDR images with labelled motion pixels. The training may include iteratively adjusting the parameters of the internal layers of the neural network to approximate the predicted motion pixels with the labeled motion pixels.

Based on the optical flow map, a motion probability map may be determined for each of the LDR images. In some embodiments, a dilation process may be performed on the motion probability map in order to increase the continuity of motion. Dilation adds pixels to the boundaries of objects in an image. Subsequently, during the motion weighting calculation phase, the motion probability maps may be aggregated to determine the motion probabilities for the pixels in the LDR images. The motion probability of a pixel indicates how likely the pixel is related to a moving object across the LDR images.

FIG. 4A illustrates an exemplary 2-dimensional (2D) fusion tensor for HDR fusion, according to some embodiments of this specification. The 2D fusion tensor serves as a fusion policy for assigning fusion weights to the motion pixels. Each motion pixel exists in multiple LDR images and has corresponding motion weights. The motion weights of a motion pixel directly determine, during HDR fusion, which exposure setting of the motion pixel should be adopted (i.e., which LDR image the motion pixel should be adopted from).

The 2D fusion tensor in FIG. 4A is configured for HDR fusion on two exposure settings (e.g., two LDR images). When the number of exposure settings increases, the fusion tensor may be adjusted to the same number of dimensions as the exposure setting number. The following description uses the 2D fusion tensor as an example to explain the configuration of the fusion tensor dimensions and the region segmentation/weight assignments within the fusion tensor.

As shown in FIG. 4A, the 2D fusion tensor may include a 2D matrix, with two dimensions respectively corresponding to the two exposure settings. Each of the dimensions covers a pixel value range. In some embodiments, the pixel value range may be determined based on the number of bits representing each pixel. For instance, if the LDR images have 10-bit pixels, each dimension of the fusion tensor covers a pixel value range of [0, 1023] (2 to the 10^{th} power). Note that the pixel values of the pixels in the short-exposure image (e.g., darker) may be clustered in the lower section of the pixel value range. Thus, the pixel values of the pixels in the short-exposure image may be scaled up by a factor so that they have a uniform value distribution as the pixel values for the pixels in the long-exposure image.

The fusion tensor may be divided into multiple regions with each region corresponding to one of the exposure settings and including fusion weights of the same value. That is, when a motion pixel is mapped to one of the regions in the fusion tensor based on its two pixel values, it will be assigned the corresponding fusion weight in the specific region. The fusion weight may be a binary value indicating which exposure setting should be adopted for the motion pixel during the fusion process.

For instance, the fusion tensor in FIG. 4A may be divided into four regions, two of which correspond to the long-exposure setting (marked with L), and the other two correspond to the short-exposure setting (marked with S). As shown, the fusion tensor is divided using a hyperbola curve and a pair of linear lines. The two regions corresponding to the long-exposure setting are connected, whereas the two regions corresponding to the short-exposure setting are disconnected.

For example, the fusion tensor may be used in the following way. When a motion pixel has low pixel values in both short and long-exposure settings (dark in both settings), it is likely mapped into region 1 in FIG. 4A. In this case, the short-exposure setting has more noise information in comparison to the long-exposure setting, and thus the long-exposure setting is adopted. When the motion pixel has a high pixel value in the short-exposure setting and a low pixel value in the long-exposure setting, or a low pixel value in the short-exposure setting and a high pixel value in the long-exposure setting (the pixel is much more bright in one setting than the other setting), the motion pixel is likely mapped into region 3 or region 4. In these cases, the long-exposure image may not contain effective information and thus the short-exposure setting is adopted. For other cases, the long-exposure setting is adopted because it contains less noise and more image information (corresponding to region 2).

FIG. 4B illustrates a more specific implementation of the 2D fusion tensor, in which the regions are represented with fusion weights. The fusion weights within the same region (e.g., region 1 in FIG. 4A) may have the same value. In 2D fusion tensor cases, each fusion weight may be a binary value. For instance, to minimize the storage footprint, each weight may be a bit with possible values 0 and 1, e.g., 0 means adopting a short-exposure setting, and 1 means adopting a long-exposure setting. Each weight may be indexed by a combination of pixel values from the plurality of dimensions of the fusion tensor. For example, a motion pixel has two pixel values from the two exposure settings, and the two pixel values may be mapped to the corresponding dimensions of the fusion tensor. The mapped points on the x-axis and y-axis of the fusion tensor may locate corresponding fusion weights for the motion pixel.

FIG. 4C illustrates an exemplary 3-dimensional fusion tensor for HDR fusion, according to some embodiments of this specification. As explained above, the number of dimensions in the fusion tensor is consistent with the number of exposure settings used in the HDR fusion. When the HDR fusion is based on three exposure settings, e.g., a short exposure, a first long exposure (e.g., a medium exposure), and a second long exposure (e.g., a long exposure), the fusion tensor may be a 3D matrix as shown in FIG. 4C. When mapping pixels to the fusion tensor, the pixel values corresponding to the short exposure and the first long exposure may be scaled up based on the second long exposure so that the pixel values for all exposure settings have a uniform distribution.

When a pixel is mapped to a weight in the fusion tensor, the weight will be used as the fusion weight during HDR fusion. The fusion weight determines which exposure setting is adopted for the particular pixel. Since there are three exposure settings, each weight in the fusion tensor should be able to represent which one of the three settings should be adopted during HDR fusion. An exemplary implementation is using two bits for each weight to minimize the storage footprint, e.g., 00 means adopting the short-exposure setting, 01 means adopting the first long-exposure setting, and 10 means adopting the second long-exposure setting. Another exemplary implementation is using a bit map (with three bits) to indicate which setting should be adopted.

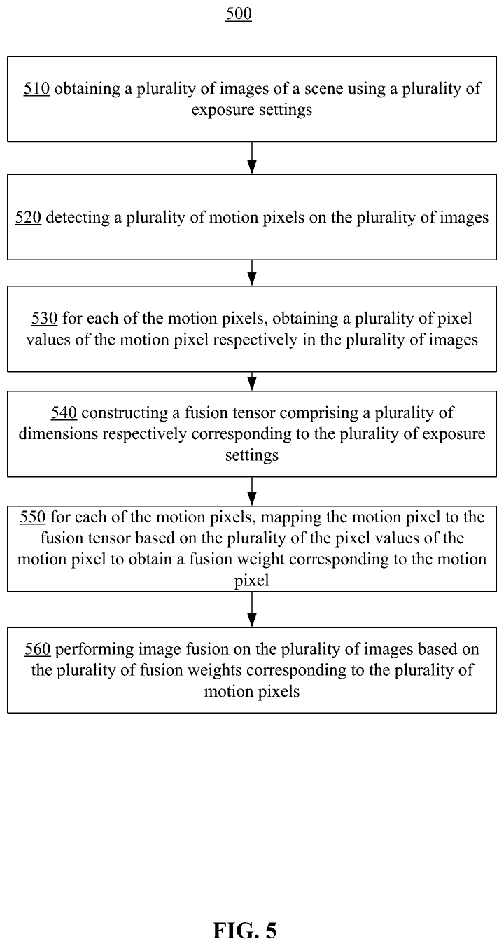

FIG. 5 illustrates an exemplary method 500 for HDR fusion using a fusion tensor, according to some embodiments of this specification. The steps illustrated in FIG. 5 are for illustration purposes. Depending on the implementation, the method 500 may include fewer, more, or alternative steps.

Block 510 includes obtaining a plurality of images of a scene using a plurality of exposure settings. In some embodiments, the plurality of images comprise a plurality of low dynamic range (LDR) images, and the plurality of exposure settings comprise at least a short-exposure and a long-exposure.

Block 520 includes detecting a plurality of motion pixels on the plurality of images. In some embodiments, the detecting the plurality of motion pixels comprises: performing pixel value normalization on the plurality of images based on the plurality of exposure settings to obtain a plurality of normalized images; constructing a motion probability map based on differences among the plurality of normalized images; and performing dilation process on the motion probability map to optimize continuity of motion. In some embodiments, the detecting the plurality of motion pixels further comprises: performing noise level normalization on the plurality of images.

Block 530 includes for each of the motion pixels, obtaining a plurality of pixel values of the motion pixel respectively in the plurality of images. In some embodiments, the obtaining the plurality of pixel values for each motion pixel respectively in the plurality of images comprises: in response to the motion pixel comprising a plurality of color channels, determining a brightness value of the motion pixel in each of the plurality of color channels in each of the plurality of plurality of images.

Block 540 includes constructing a fusion tensor comprising a plurality of dimensions respectively corresponding to the plurality of exposure settings, wherein: each dimension of the fusion tensor comprises a pixel value range, and the fusion tensor comprises a plurality of weights, each weight being indexed by a combination of pixel values from the plurality of dimensions of the fusion tensor. In some embodiments, the constructing the motion probability map comprises: selecting one of the plurality of images as a base frame; for each of the plurality of images other than the base frame, obtaining a pixel-wise optical flow map by inputting the image and the base frame into a trained motion estimation machine learning model; and constructing the motion probability map based on the pixel-wise optical flow map for each of the plurality of images other than the base frame.

In some embodiments, the constructing the fusion tensor comprises: determining a number of bits representing each pixel in the plurality of images; constructing each dimension of the fusion tensor covering a range of value based on the number of bits; dividing the fusion tensor into a plurality of regions, each region corresponding to one of the plurality of exposure settings; and generating the plurality of weights of the fusion tensor, wherein weights in a same region are same. In some embodiments, the plurality of exposure settings comprise a long-exposure setting and a short-exposure setting, and the fusion tensor is a 2-dimensional matrix comprising a long-exposure dimension and a short-exposure dimension, and the dividing the fusion tensor into the plurality of regions comprises: dividing the 2-dimensional matrix into: a first region and a second region both corresponding to the long-exposure setting, wherein the first region and the second region are connected; and a third region and a fourth region both corresponding to the short-exposure setting, wherein the third region and the fourth region are disconnected. In some embodiments, the dividing the 2-dimensional matrix comprises dividing the 2-dimensional matrix using a hyperbola curve and a pair of linear lines.

Block 550 includes for each of the motion pixels, mapping the motion pixel to the fusion tensor based on the plurality of the pixel values of the motion pixel to obtain a fusion weight corresponding to the motion pixel. In some embodiments, the fusion weight corresponding to the motion pixel identifies one of the plurality of images.

Block 560 includes performing image fusion on the plurality of images based on the plurality of fusion weights corresponding to the plurality of motion pixels.

In some embodiments, the method 500 may further include: for pixels other than the plurality of motion pixels, performing the image fusion on the plurality of images based on fusion weights computed using linear or non-linear curves.

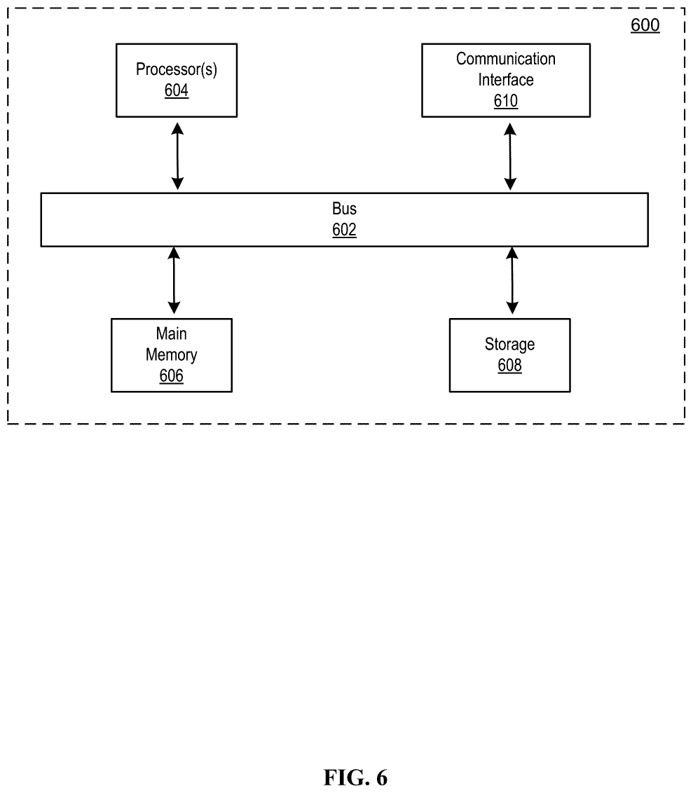

FIG. 6 is a schematic diagram of an example computing system 600 for HDR fusion using a fusion tensor, according to some embodiments of this specification. The computer system 600 may be implemented in any of the components of the systems illustrated in FIGS. 1-5. One or more of the example methods illustrated by FIGS. 1-5 may be performed by one or more implementations of the computer system 600.

The computer system 600 may include a bus 602 or other communication mechanism for communicating information, and one or more hardware processor(s) 604 coupled with bus 602 for processing information. Hardware processor(s) 604 may be, for example, one or more general purpose microprocessors.

The computer system 600 may also include a main memory 606, such as a random-access memory (RAM), cache and/or other dynamic storage devices, coupled to bus 602 for storing information and instructions executable by processor(s) 604. Main memory 606 also may be used for storing temporary variables or other intermediate information during execution of instructions by processor(s) 604. Such instructions, when stored in storage media accessible to processor(s) 604, render computer system 600 into a special-purpose machine that is customized to perform the operations specified in the instructions. The computer system 600 may further include a read only memory (ROM) 606 or other static storage device coupled to bus 602 for storing static information and instructions for processor(s) 604. A storage device 608, such as a magnetic disk, optical disk, or USB thumb drive (flash drive), etc., may be provided and coupled to bus 602 for storing information and instructions.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the operations, methods, and processes described herein are performed by computer system 600 in response to processor(s) 604 executing one or more sequences of one or more instructions contained in main memory 606. Such instructions may be read into main memory 606 from another storage medium, such as storage device 608. Execution of the sequences of instructions contained in main memory 606 may cause processor(s) 604 to perform the process steps described herein. In alternative embodiments, hard-wired circuitry may be used in place of or in combination with software instructions.

The main memory 606, the ROM 606, and/or the storage device 608 may include non-transitory storage media. The term “non-transitory media,” and similar terms, as used herein refers to media that stores data and/or instructions that cause a machine to operate in a specific fashion, that excludes transitory signals. Such non-transitory media may comprise non-volatile media and/or volatile media. Non-volatile media includes, for example, optical or magnetic disks, such as storage device 608. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 600 may include a network interface 610 coupled to bus 602. Network interface 610 may provide a two-way data communication coupling to one or more network links that are connected to one or more local networks. For example, network interface 610 may be an integrated services digital network (ISDN) card, cable modem, satellite modem, or a modem that provides a data communication connection to a corresponding type of telephone line. As another example, network interface 610 may be a local area network (LAN) card to provide a data communication connection to a compatible LAN (or WAN component to communicated with a WAN). Wireless links may also be implemented. In any such implementation, network interface 610 may send and receive electrical, electromagnetic or optical signals that carry digital data streams representing various types of information.

The computer system 600 can send messages and receive data, including program code, through the network(s), network link, and network interface 610. In the Internet example, a server might transmit a requested code for an application program through the Internet, the ISP, the local network, and the network interface 610.

The received code may be executed by processor(s) 604 as it is received, and/or stored in storage device 608, or other non-volatile storage for later execution.

Each process, method, and algorithm described in the preceding sections may be embodied in, and fully or partially automated by, code modules executed by one or more computer systems or computer processors comprising computer hardware. The processes and algorithms may be implemented partially or wholly in the application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions that cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), or any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted or executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C.” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might.” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for generating images, comprising:
obtaining a plurality of images of a scene using a plurality of exposure settings;
detecting a plurality of motion pixels on the plurality of images;
for each of the motion pixels, obtaining a plurality of pixel values of the motion pixel respectively in the plurality of images;
constructing a fusion tensor comprising a plurality of dimensions respectively corresponding to the plurality of exposure settings, wherein:
each dimension of the fusion tensor comprises a pixel value range, and
the fusion tensor comprises a plurality of weights, each weight being indexed by a combination of pixel values from the plurality of dimensions of the fusion tensor;
for each of the motion pixels, mapping the motion pixel to the fusion tensor based on the plurality of the pixel values of the motion pixel to obtain a fusion weight corresponding to the motion pixel; and
performing image fusion on the plurality of images based on the plurality of fusion weights corresponding to the plurality of motion pixels.

2. The method of claim 1, wherein the plurality of images comprise a plurality of low dynamic range (LDR) images, and the plurality of exposure settings comprise at least a short-exposure and a long-exposure.

3. The method of claim 1, wherein the detecting the plurality of motion pixels comprises:
performing pixel value normalization on the plurality of images based on the plurality of exposure settings to obtain a plurality of normalized images;
constructing a motion probability map based on differences among the plurality of normalized images; and
performing dilation process on the motion probability map to optimize continuity of motion.

4. The method of claim 3, wherein the constructing the motion probability map comprises:
selecting one of the plurality of images as a base frame;
for each of the plurality of images other than the base frame, obtaining a pixel-wise optical flow map by inputting the image and the base frame into a trained motion estimation machine learning model; and
constructing the motion probability map based on the pixel-wise optical flow map for each of the plurality of images other than the base frame.

5. The method of claim 3, wherein the detecting the plurality of motion pixels further comprises:
performing noise level normalization on the plurality of images.

6. The method of claim 1, wherein the constructing the fusion tensor comprises:
determining a number of bits representing each pixel in the plurality of images;
constructing each dimension of the fusion tensor covering a range of value based on the number of bits;
dividing the fusion tensor into a plurality of regions, each region corresponding to one of the plurality of exposure settings; and
generating the plurality of weights of the fusion tensor, wherein weights in a same region are same.

7. The method of claim 6, wherein the plurality of exposure settings comprise a long-exposure setting and a short-exposure setting, and the fusion tensor is a 2-dimensional matrix comprising a long-exposure dimension and a short-exposure dimension, and
the dividing the fusion tensor into the plurality of regions comprises:
dividing the 2-dimensional matrix into:
a first region and a second region both corresponding to the long-exposure setting, wherein the first region and the second region are connected; and
a third region and a fourth region both corresponding to the short-exposure setting, wherein the third region and the fourth region are disconnected.

8. The method of claim 7, wherein the dividing the 2-dimensional matrix comprises dividing the 2-dimensional matrix using a hyperbola curve and a pair of linear lines.

9. The method of claim 1, wherein the obtaining the plurality of pixel values for each motion pixel respectively in the plurality of images comprises:
determining a brightness value of the motion pixel in each of the plurality of images.

10. The method of claim 1, wherein the obtaining the plurality of pixel values for each motion pixel respectively in the plurality of images comprises:
in response to the motion pixel comprising a plurality of color channels, determining a brightness value of the motion pixel in each of the plurality of color channels in each of the plurality of plurality of images.

11. The method of claim 1, wherein the fusion weight corresponding to the motion pixel identifies one of the plurality of images.

12. The method of claim 11, wherein the performing image fusion on the plurality of images based on the plurality of fusion weights corresponding to the plurality of motion pixels comprises:
for each of the plurality of motion pixels, adopting the motion pixel from the one image identified by the fusion weight corresponding to the motion pixel.

13. The method of claim 11, further comprising:
for pixels other than the plurality of motion pixels, performing the image fusion on the plurality of images based on fusion weights computed using linear or non-linear curves.

14. A system, comprising one or more processors and one or more non-transitory computer-readable memories coupled to the one or more processors and configured with instructions executable by the one or more processors to cause the system to perform operations comprising:
obtaining a plurality of images of a scene using a plurality of exposure settings;
detecting a plurality of motion pixels on the plurality of images;
for each of the motion pixels, obtaining a plurality of pixel values of the motion pixel respectively in the plurality of images;
constructing a fusion tensor comprising a plurality of dimensions respectively corresponding to the plurality of exposure settings, wherein:
each dimension of the fusion tensor comprises a pixel value range, and
the fusion tensor comprises a plurality of weights, each weight being indexed by a combination of pixel values from the plurality of dimensions of the fusion tensor;
for each of the motion pixels, mapping the motion pixel to the fusion tensor based on the plurality of the pixel values of the motion pixel to obtain a fusion weight corresponding to the motion pixel; and
performing image fusion on the plurality of images based on the plurality of fusion weights corresponding to the plurality of motion pixels.

15. The system of claim 14, wherein the constructing the fusion tensor comprises:
determining a number of bits representing each pixel in the plurality of images;
constructing each dimension of the fusion tensor covering a range of value based on the number of bits;
dividing the fusion tensor into a plurality of regions, each region corresponding to one of the plurality of exposure settings; and
generating the plurality of weights of the fusion tensor, wherein weights in a same region are same.

16. The system of claim 15, wherein the plurality of exposure settings comprise a long-exposure setting and a short-exposure setting, and the fusion tensor is a 2-dimensional matrix comprising a long-exposure dimension and a short-exposure dimension, and
the dividing the fusion tensor into the plurality of regions comprises:
dividing the 2-dimensional matrix into:
a first region and a second region both corresponding to the long-exposure setting, wherein the first region and the second region are connected; and
a third region and a fourth region both corresponding to the short-exposure setting, wherein the third region and the fourth region are disconnected.

17. The system of claim 16, wherein the dividing the 2-dimensional matrix comprises dividing the 2-dimensional matrix using a hyperbola curve and a pair of linear lines.

18. The system of claim 14, wherein the obtaining the plurality of pixel values for each motion pixel respectively in the plurality of images comprises:
in response to the motion pixel comprising a plurality of color channels, determining a brightness value of the motion pixel in each of the plurality of color channels in each of the plurality of plurality of images.

19. The system of claim 14, wherein the performing image fusion on the plurality of images based on the plurality of fusion weights corresponding to the plurality of motion pixels comprises:
for each of the plurality of motion pixels, adopting the motion pixel from the one image identified by the fusion weight corresponding to the motion pixel.

20. A non-transitory computer-readable storage medium configured with instructions executable by one or more processors to cause the one or more processors to perform operations comprising:
obtaining a plurality of images of a scene using a plurality of exposure settings;
detecting a plurality of motion pixels on the plurality of images;
for each of the motion pixels, obtaining a plurality of pixel values of the motion pixel respectively in the plurality of images;
constructing a fusion tensor comprising a plurality of dimensions respectively corresponding to the plurality of exposure settings, wherein:
each dimension of the fusion tensor comprises a pixel value range, and
the fusion tensor comprises a plurality of weights, each weight being indexed by a combination of pixel values from the plurality of dimensions of the fusion tensor;
for each of the motion pixels, mapping the motion pixel to the fusion tensor based on the plurality of the pixel values of the motion pixel to obtain a fusion weight corresponding to the motion pixel; and
performing image fusion on the plurality of images based on the plurality of fusion weights corresponding to the plurality of motion pixels.
